(19) United States
(12) Patent Application Publication
(10) Pub. No.: US 2025/0368768 A1
(43) Pub. Date: Dec. 4, 2025

(54) Rheology control additive compositions

(71) Applicant: Arkema France, Colombes (FR)

(72) Inventors: Anne-Laure BROCAS, Lacq (FR); Céline LABARTHE, Lacq (FR)

(73) Assignee: Arkema France, Colombes (FR)

(21) Appl. No.: 18/875,218

(22) PCT Filed: Jun. 8, 2023
(86) PCT No.: PCT/FR2023/050818

§ 371 Date: Dec. 16, 2024

(30) Foreign Application Priority Data
Jun. 16, 2022 (FR) FR2205888

(51) Int. Cl. C08F 287/00; B33Y 70/10; C08F 2/50; C08K 5/103; C08K 5/20; C08K 7/20; C09D 7/40; C09D 7/43; C09D 7/63; C09D 7/65; C09D 151/00; C09J 151/00

(52) U.S. Cl. CPC C08F 287/00; B33Y 70/10; C08F 2/50; C08K 5/103; C08K 5/20; C08K 7/20; C09D 7/43; C09D 7/63; C09D 7/65; C09D 7/70; C09D 151/006; C09J 151/006

(57) ABSTRACT

The present invention relates to additive compositions for controlling rheology and mechanical properties that can be used in polymerizable compositions, sealants, paints or else adhesives. These compositions provide an improvement in the control of the rheology; they have in particular a viscosity and a yield stress which can be adjusted. Owing to the nature of the constituents therein, they provide reinforcement of the mechanical properties of the formulations containing them.

### FIELD OF THE INVENTION

The present invention relates to additive compositions for controlling rheology and mechanical properties that can be used in polymerizable compositions, sealants, paints or else adhesives. These compositions provide an improvement in the control of the rheology; they have in particular a viscosity and a yield stress which can be adjusted. They also provide reinforcement of the mechanical properties of the formulations containing them.

They are useful in formulations of polymerizable monomers, adhesives, sealants or else paints and more generally in all formulations when an increase in viscosity and yield stress is desired.

The formulation of the compositions of the invention provides solutions for manufacturing objects by a three-dimensional (3D) printing process, and more particularly large objects that can have dimensions of several meters and thicknesses of several centimeters. In addition, the compositions of the invention allow effective dissipation of the exotherms generated during the polymerization of polymerizable formulations containing them. Owing to the nature of the compositions of the invention, the mechanical properties of the formulations comprising these polymerized compositions are improved and the products obtained from polymerized formulations comprising the compositions of the invention exhibit low shrinkage. The compositions of the invention also allow effective control of the rheology of sealant, paint or else adhesive formulations, with small amounts of these compositions.

### BACKGROUND

With the need to control the rheology of polymerizable monomer formulations, sealants, paints or else adhesives, the need has emerged for continual improvement in the behavior of these formulations. The use of rheology additives or mixtures of rheology additives is therefore common in these technical fields. In particular, viscous behaviors are often desired for these formulations, and sometimes the absence of flow during application.

For example, the monomers which are used in polymerization in different application fields usually have a very low viscosity because they are usually compounds of low molecular weight. Their yield stress is close to zero. The use of functional oligomers or the addition of polymers makes it possible to increase the viscosity but can be a source of other drawbacks, and the yield stress remains insufficient.

In formulations such as sealants and adhesives, paints, or in 3D printing, it is often necessary to increase the viscosity and yield stress of these formulations with or without monomers for applicational reasons and in particular to avoid the flow of material before the polymerization process is completed or during the application of non-polymerizable formulations. Generally, compositions are desired whose flow is limited, or even non-existent, or else controlled according to the fields of use. The exothermicity generated during the polymerization of monomers must also be managed to avoid the potential defects generated. Finally, the polymerized monomer compositions generally exhibit insufficient mechanical properties.

3D printing is a technical field widely used in industry and leisure. This technology allows the preparation of single objects from a definition of the object in the form of a computer file giving the dimensional parameters of the object to be printed.

It therefore allows additive manufacturing (AM) of a real object from a virtual object. It is based on the slicing of the virtual 3D object into thin 2D layers. These thin layers are deposited one by one by fixing them on the preceding layers, so making it possible to manufacture the real object. In the case of 3D printing using polymerization processes, the fixing of the layers on each other is possible when, for example, the constituent material of the object is a monomer composition extruded through a nozzle guided for the manufacture of the object, which is polymerized once deposited on the previous lamina.

Until now, this approach to manufacturing objects was reserved for the manufacture of small objects, most of the time being able to a certain extent to be free from the constraints of perfect control of viscosity and yield stress. When it comes to manufacturing large objects, new problems arise that are negligible for small objects.

For example, in 3D printing of large-size objects, the rheology enabling good stability of the material at the nozzle outlet is much more demanding, exothermic phenomena are more present because heat is difficult to eliminate, and poorly controlled post-polymerization shrinkage leads to poor-quality objects. For the manufacture of large objects, rather than thin layers being superimposed, the layers are a few centimeters thick. The phenomena of flow and of shrinkage on polymerization are exacerbated and are presently poorly resolved. When manufacturing large objects, the user is also seeking good mechanical strength of these objects.

In the state of the art known at present, it is difficult to have a polymerizable formulation which allows the manufacture of large objects with good mechanical strength, while maintaining effective control of shrinkage, limiting the exothermicity and with effective control of the dimensional definition of the different overlapping laminas resulting from the rheology during the process of manufacturing these laminas. The flow of the formulation to be polymerized takes place through a nozzle and must maintain a dimensional stability characterized by sufficient viscosity and yield stress. This set of technical problems is poorly solved at present.

Because of the low viscosity provided by the monomers, formulations comprising oligomers are used in the prior art, which complicates the formulations, increases costs, and does not always make it possible to obtain transparent compositions when this is desired. EP0802455 is an example thereof with oligomers which are difficult to manufacture and therefore expensive.

In the extrusion of polymerizable compositions, WO21029945 uses a similar approach with the use of reactive oligomers in the form of acrylates. An alternative is described in WO21183396 but assumes an additional step of performing a pre-polymerization, this to increase the viscosity during use in a 3D printing process by the technique of extrusion through a nozzle, but this adds an additional step. In these examples, despite the increases in the viscosity, the yield stresses remain low and a flow of the material is still observed.

The applicant has sought to improve formulations, one example of which consists of monomers and initiator, because the combination of these components alone does not allow the correct construction of an object by irradiative or thermal polymerization, owing to a viscosity and a yield stress that are too low. The shrinkage on polymerization is also too great and the objects have many defects in appearance.

The addition of block copolymers within these formulations makes it possible to improve the mechanical properties, this being known to those skilled in the art. The presence of the block copolymers, moreover, makes a positive contribution to the rheology, this being also known to those skilled in the art.

However, the rheological behavior of these formulations remains insufficient or requires the use of large quantities of block copolymers without resolving the flow phenomena, because the yield stress remains insufficient. Diamides, and in particular fatty acid diamides, are widely used in the formulation field as agents for rheology control. Mention may be made, for example, of EP3613728.

These diamides are sometimes combined with castor oil. Thus, in EP3919546, compositions of diamides, hydrogenated castor oil and a particular polyamide, either in pairs or all three together, are disclosed as rheology additives.

In EP3131996, the combination of polyamide and hydrogenated castor oil is also described.

It is observed that the changes in rheology associated with the use of these diamides and hydrogenated castor oil, in combination or not, are insufficient in view of the needs that may arise from formulations, whether polymerizable or not, in sealants, paints or else adhesives. In the case of polymerizable formulations, the particular case of applications in 3D printing is a good example of the need to manage the rheology of the formulations.

When using these compounds, combined with one or more monomers, it is necessary to use large amounts of them to have a significant effect. This may have the consequence of degrading certain properties of the polymerized monomer formulations.

The combination of block copolymer, diamides and/or triamides and hydrogenated castor oil in a polymerizable monomer formulation, i.e., in the presence of a polymerization initiator, is an example of a solution to the technical problems relating to rheology control, mechanical properties and polymerization management. In particular, very significant effects of increase in viscosity and yield stress are observed even when using small amounts of the compositions of the invention. The combination of block copolymer, diamides and/or triamides and castor oil provides a surprising effect and allows the quantity of these additives to be limited while providing improvements in the mechanical properties of the products obtained and with an exothermicity during polymerizations that are better managed than in the absence of the combination of these three compounds. The combined use of block copolymers, amides and castor oil therefore provides a summation of unexpected technical effects (improved rheology, improved mechanical properties, and limited exothermicities and shrinkage).

Thus, in addition to the one or more monomer components, the applicant has found that the combination of small amounts of castor oil, diamide and/or triamide, and block copolymers provides a viscosity and a yield stress that are in line with the needs generated in formulations of sealants and adhesives, paints, or in 3D printing. The combined presence of block copolymer, amide and hydrogenated castor oil is necessary to maximize the effects on the rheology of the formulations containing them, and the technical effect obtained is far superior to the combination of only two of these compounds.

In the case of 3D printing, the compositions of the invention formulated with monomers exhibit good stability of the bead of the formulation before polymerization and allow them to be placed on the previously polymerized lamina with no defect. The objects obtained using these compositions also exhibit good mechanical properties. The combination of castor oil, diamide and/or triamide, and block copolymers in a composition comprising one or more monomers makes it possible to obtain a significant effect which can solve the existing technical problems in applications requiring high viscosities or alternatively an adjustment of these viscosities, with sufficient yield stresses, and accomplishes this with small amounts of these compounds.

The amounts of castor oil, diamide and/or triamide, and block copolymers can be variable and make it possible to finely adjust the rheological constraints associated with the formulation of sealants, adhesives, paints and during the manufacture of objects by 3D printing, while providing benefits in shrinkage, management of exothermal energy, and mechanical properties. Fillers can be added within the compositions of the invention formulated with monomers, while retaining the advantage of the combination of castor oil, diamide and/or triamide, and block copolymers.

The compositions of the invention can also be used with ingredients derived from natural materials such as vegetable oils or fibers, whether monomers, block copolymers, diamides and/or triamides, castor oil, or fillers. When fillers are present within the compositions of the invention, fillers derived from recycling of polymer materials, filled or not, may be included therein, such as composite materials, which gives the compositions of the invention a favorable carbon balance and recyclability of the materials at the end of their life.

### SUMMARY OF THE INVENTION

The invention relates to a mass composition comprising the following mixture C:
at least one block copolymer in proportions of between 50% and 99%;
hydrogenated castor oil in proportions of between 0.5% and 25%;
at least one fatty acid diamide and/or at least one fatty acid triamide in proportions of between 0.5% and 25%;
   the % being expressed in mass form for the mass total of C.

### DETAILED DESCRIPTION

The present invention is a composition comprising three classes of compounds, consisting of block copolymers, hydrogenated castor oil, and polyamides. They can be in the form of a mixture of these three classes of compounds prepared dry (mixture of powders and/or granules of the compounds) or prepared by melting using a suitable mixing device. The invention also relates to the use of the compositions of the invention as organogelators in formulations containing them.

An organogelator is understood to mean compositions which make it possible to modify the rheology of liquid formulations.

The block copolymers useful in the context of the present invention are multiblock copolymers, preferably not containing butadiene. They consist of A blocks (called hard blocks) having a glass transition temperature Tg of greater than 25° C., preferably greater than 50° C. and more preferably greater than 70° C., and B blocks (called soft blocks) having a Tg of less than 0° C., preferably less than −25° C., of formula (A-B)ₘ with m taking values of between 2 and 1000 and preferably between 4 and 500, or preferably linear or star-shaped and of formula (A)ₙB or (B)nA, and preferably (A)ₙB, with n taking values of 2 or 3, these being di-block or tri-block and preferably tri-block, linear or star-shaped copolymers. A combination of di-block and tri-block copolymers constitutes one variant of the invention.

The term “glass transition temperature” or “Tg” denotes the temperature at which the polymer material changes from the vitreous state to a non-vitreous state, corresponding to a certain mobility of the polymer chains between each other. The glass transition temperature is determined by dynamic mechanical analysis (DMA), for example according to the method specified in the “Examples” section.

The expression “block copolymer” designates a copolymer having a plurality of different polymer segments, with each segment, also denoted “block”, consisting of the sequencing of monomers which may be identical or different. Thus, each segment or block may be a homopolymer or a copolymer.

Preferably, the A blocks comprise the sequencing of monomers chosen from linear or branched, cyclic or non-cyclic C₁ to C₁₈alkyl (meth)acrylates, substituted or not by polar and/or hydrophilic functions, and in particular methyl methacrylate, possibly resulting from a process of recycling by depolymerization, styrene and substituted styrenes, isobornyl (meth)acrylates, (meth)acrylic acids and alkylacrylamides.

Polar and/or hydrophilic groups are understood to mean groups such as groups of carboxylic (—COOH), hydroxyl (—OH) or amide (—CONH) type, or else ethylene glycol or polyethylene glycol substituted or unsubstituted on their terminal function by alkyl, phosphate, phosphonate or sulfonate groups.

More preferably, the A blocks comprise the sequencing of monomers, alone or in combination, chosen from methyl methacrylate, optionally resulting from a process of recycling by depolymerization, styrene, isobornyl acrylate, acrylic acid or methacrylic acid, dimethylacrylamide, diethylacrylamide or isopropylacrylamide.

According to one variant, the following monomers may form part of the A block: hydroxylated (meth)acrylates, in particular 2-hydroxyethyl methacrylate, 2-hydroxypropyl methacrylate, 4-hydroxybutyl methacrylate, polyethylene glycol or glycol (meth)acrylates substituted or unsubstituted on their terminal function by alkyl, phosphate, phosphonate or sulfonate groups.

Preferably, the B blocks will preferentially consist of the sequencing of monomers chosen from butyl acrylate,

2-ethylhexyl acrylate, octyl, nonyl and lauryl acrylate and mixtures thereof, optionally mixed with styrene.

More preferably, the B blocks consist of the sequencing of butyl acrylate monomers.

Mention may thus be made of the following tri-block, di-block and star triblock copolymers in a non-limiting manner which can be used in the context of the invention, alone or as a mixture:

pMMA-pBuA-pMMA, p(MMAcoMAA)-pBuA-p(MMAcoMAA), p(MMAcoAA)-pBuA-p(MMAcoAA), pMMA-p(BuAcoSty)-pMMA, p(MMAcoMAA)-p(BuAcoSty)-p(MMAcoMAA), pMMA-p(BuAcoAA)-pMMA, p(MMAcoDMA)-pBuA-p(MMAcoDMA), p(MMAcolPA)-pBuA-p(MMAcolPA) and preferably p(MMAcoDMA)-pBuA-p(MMAcoDMA), p(MMAcolPA)-pBuA-p(MMAcolPA), pMMA-pBuA-pMMA.

PMMA-pBuA, p(MMAcoMAA)-pBuA, p(MMAcoAA)-pBuA, PMMA-p(BuAcoSty), p(MMAcoMAA)-p(BuAcoSty), PMMA-p(BuAcoAA), p(MMAcoDMA)-pBuA-, p(MMAcolPA)-pBuA- and preferably p(MMAcoDMA)-pBuA, p(MMAcolPA)-pBuA.

pBuA-(pMMA)₃, pBuA-(p(MMAcoMAA))₃, pBuA-(p(MMAcoAA))₃, p(BuAcoSty)-(pMMA)₃, p(BuAcoSty)-(p(MMAcoMAA))₃, p(BuAcoAA)-(pMMA)₃, pBuA-(p(MMAcoDMA))₃, pBuA-(p(MMAcolPA))₃ and preferably pBuA-(p(MMAcoDMA))₃, pBuA-(p(MMAcolPA))₃, p(BuAcoSty)-(p(MMAcoMAA))₃.

In all of these block copolymers, MMA may be substituted wholly or partially by IBOA and/or IBOMA.

With MMA: Methyl methacrylate, MAA: Methacrylic acid, AA: Acrylic acid, BuA: Butyl acrylate, Sty: Styrene, DMA: Dimethylacrylamide, IPA: Isopropylacrylamide, IBOA: Isobornyl acrylate, IBOMA: Isobornyl methacrylate

The block copolymers useful in the context of the present invention typically have a weight-average molecular mass, measured by SEC with polystyrene calibration, of between 10 000 and 200 000 g/mol and preferably between 80 000 and 180 000 g/mol, with a hard block/soft block mass ratio of between 75/25 and 40/60.

The block copolymers useful in the context of the present invention are preferably prepared by controlled radical polymerization, without excluding other methods of preparation. Controlled radical polymerizations make it possible to obtain block copolymers in sequential steps within the same process operation. For example, the block copolymers can be prepared by RAFT (radical addition fragmentation transfer) polymerization or by nitroxide-controlled polymerization, also known as NMP (nitroxide-mediated polymerization). Preferably, the block copolymers are prepared by NMP, in particular by NMP using the N-tert-butyl-1-diethylphosphono-2,2-dimethylpropyl nitroxide counter-radical. The synthesis of block copolymers using this counter-radical is described in particular in EP1526138.

The block copolymers are present within the mixture C in proportions by mass of between 50% and 99%, preferably between 60% and 95% and more preferably between 70% and 95%, endpoints included.

Hydrogenated castor oil is a compound found commercially under CAS No. 8001-78-3. Hydrogenated castor oil consists of 85% to 90% by mass of ricinoleic acid triglyceride, a large part of the double bonding in which is hydrogenated. There are also smaller quantities therein of hydrogenated linolenic acid triglycerides, hydrogenated oleic acid triglycerides and hydrogenated stearic acid triglycerides, these being the main ones.

The hydrogenated castor oil is present within the mixture C in proportions by mass of between 0.5% and 25%, preferably between 2.5% and 20% and preferably between 2.5% and 15%, endpoints included.

The compositions of the invention comprise at least one polyamide, that is to say compounds comprising at least two amide functions. This polyamide is preferably at least one fatty acid diamide and/or at least one fatty acid triamide.

The diamides of the compositions of the invention may be diamides derived from the condensation of at least one diamine with at least one acid or of at least one diacid with at least one amine.

The triamides of the compositions of the invention may be triamides derived from the condensation of at least one triamine with at least one acid or of at least one triacid with at least one amine.

According to a first preference, they are diamides derived from the condensation of at least one diamine with at least one fatty acid.

According to a second preference, they are triamides derived from the condensation of at least one triamine with at least one fatty acid.

According to a third preference, they are a mixture of diamides derived from the condensation of at least one diamine with at least one fatty acid and triamides derived from the condensation of at least one triamine with at least one fatty acid.

Diamides are characterized in that they comprise at least one reaction product obtained from a reaction mixture comprising:
a) at least one diamine,
the diamine being chosen from a C₂ to C₂₄ and preferably C₂ to C₁₀ aliphatic diamine, a C₆ to C₁₈ and preferably C₆ to C₁₂ cycloaliphatic diamine, a C₆ to C₂₄ and preferably C₆ to C₁₂ aromatic diamine, a C₇ to C₂₄ arylaliphatic diamine, and mixtures thereof;
b) at least one carboxylic acid,
the carboxylic acid being a C₂ to C₃₆ carboxylic acid, preferably a linear or branched, saturated or unsaturated, unsubstituted or hydroxyl group-substituted C₉ to C₂₄ fatty acid, in particular pentanoic acid, hexanoic acid, heptanoic acid, octanoic acid,
nonanoic acid, decanoic acid, undecanoic acid, and preferably substituted by a hydroxyl group, among which mention may be made of 12-hydroxystearic acid (12-HSA), 9- or 10-hydroxystearic acid (9-HSA or 10-HSA), 14-hydroxyeicosanoic acid (14-HEA) or mixtures thereof. The most preferred hydroxylated carboxylic acid is 12-hydroxystearic acid.

Triamides are characterized in that they comprise at least one reaction product obtained from a reaction mixture comprising:
a) at least one triamine,
the triamine being chosen from a C₂ to C₂₄ and preferably C₂ to C₁₀ aliphatic triamine, a C₆ to C₁₈ cycloaliphatic triamine, a C₆ to C₂₄ aromatic triamine, a C₇ to C₂₄ arylaliphatic triamine, or else polyether triamines, and mixtures thereof;
b) at least one carboxylic acid,
the carboxylic acid being a C₂ to C₃₆ carboxylic acid, preferably a linear or branched, saturated or unsaturated, unsubstituted or hydroxyl group-substituted C₉ to C₂₄ fatty acid, in particular pentanoic acid, hexanoic acid, heptanoic acid, octanoic acid,
nonanoic acid, decanoic acid, undecanoic acid, and preferably substituted by a hydroxyl group, among which mention may be made of 12-hydroxystearic acid (12-HSA), 9- or 10-hydroxystearic acid (9-HSA or 10-HSA), 14-hydroxyeicosanoic acid (14-HEA) or mixtures thereof. The most preferred hydroxylated carboxylic acid is 12-hydroxystearic acid.

At least one diamide and/or one triamide is present within the mixture C in proportions by mass of between 0.5% and 25%, preferably between 2.5% and 20% and preferably between 2.5% and 15%, endpoints included.

The (hydrogenated castor oil)/(diamide and/or triamide) mass ratio is between 1/4 and 4/1, and preferably between 1/3 and 2/3.

The compositions of the invention may also comprise a mixture M of monomers in proportions by mass of the mixture C of between 1% to 40% relative to the mass C+M, and preferably from 1% to 20% relative to the mass C+M.

Thus, the present invention comprises the compositions of the invention of the mixture C and at least one mixture M of monomers and also the use of this mixture in polymerizable formulations. The monomers of the mixture M used in the compositions of the invention may be mono- or polyfunctional, in combination or not. They are preferably derived from renewable resources. Functional is understood to mean an entity possessing a polymerizable double bond.

The monofunctional monomers may be styrene and substituted styrenes, linear or branched C₁ to C₁₈ cyclic or noncyclic, substituted or unsubstituted alkyl (meth)acrylates, alkoxyalkyl (meth)acrylates, and in particular methyl methacrylate, possibly resulting from a process of recycling by depolymerization, isobornyl (meth)acrylates with or without additional functionalities, where the additional functionalities when they are present may be of the hydroxyl, amine, epoxy, amide or phosphorus-containing type. When rapid kinetics is desirable, acrylates will be preferably chosen.

Among the preferred monomers of the invention, mention will be made in particular of styrene and of methyl, ethyl, butyl and isobornyl (meth)acrylates. Preferably, these are styrene, methyl methacrylate, possibly resulting from a process of recycling by depolymerization, or isobornyl acrylate, alone or in combination.

More preferably, they are methyl methacrylate from a process of recycling by depolymerization and/or isobornyl acrylate from renewable resources. The polyfunctional monomers carry methacrylic or acrylic functions and preferably acrylic functions, and include dipentaerythritol hexaacrylate, trimethylolpropane triacrylate, 1,6-hexanediol diacrylate, dimethylolpropane tetraacrylate, tricyclodecanedimethanol diacrylate, pentaerythritol triacrylate, polyalkoxylated pentaerythritol tetraacrylate, tripropylene glycol diacrylate, triethylene glycol dimethacrylate, ethylene glycol dimethacrylate, ethylene glycol diacrylate, 1,10-decanediol di(meth)acrylate, polyethylene glycol (meth)acrylates, dipropylene glycol diacrylate, tripropylene glycol diacrylate, polyfunctional (meth)acrylates from renewable resources, such as vegetable oil (meth)acrylates and preferably vegetable oil acrylates. As regards monomers carrying two or more (meth)acrylate functions of renewable origin, mention may be made of the monomers from the company Sartomer in the Sarbio range®, and more particularly the references 6201 (polyethylene glycol dimethacrylate 200), 6202 (1,10-dodecanediol diacrylate), 7101 (epoxy acrylate), 7106 (linseed oil acrylate), 7107 (epoxidized soybean oil diacrylate) and 7205 (polyester oligomer acrylate).

Preferably these are monomers derived from renewable resources such as acrylates of vegetable oils (linseed, soybean, corn, sunflower, tung). A combination of two or more monomers is preferred in the context of the invention, and preferably a combination of monofunctional monomers with acrylate functions and polyfunctional monomers with an acrylate function (di-, tri-, tetra-, penta- and hexaacrylate).

Monomers of the vinyl ether type may also be present in the context of the invention, in particular when the polymerization is initiated by a cationic process. They may be of any type, monofunctional or polyfunctional in terms of vinyl functions.

Preferably, a combination of monofunctional and polyfunctional monomers will be used in respective mass ratios varying from 4/1 to 1/4.

The compositions C of the invention comprising a mixture M of monomers may be polymerized using radical or cationic polymerization initiators which may or may not be activated with the aid of electromagnetic radiation, in proportions by mass of between 0.1% and 5% of the mass of the composition M. Initiators may also undergo thermal activation. Preferably, they are polymerization initiators sensitive to electromagnetic radiation and more particularly to ultraviolet (UV) radiation. Such initiators are called photoinitiators.

Thus, the invention also relates to the compositions of the invention comprising at least one monomer, an initiator, and more particularly a photoinitiator sensitive to ultraviolet (UV) radiation.

Photoinitiators are compounds capable of generating free radicals or cations when these compounds are exposed to electromagnetic radiation. Preferably, the electromagnetic radiation has wavelengths in the ultraviolet or visible range, but it would not be departing from the scope of the invention to use wavelengths in shorter wavelength ranges (x-rays or gamma rays) or longer wavelength ranges (infrared or even beyond).

The photoinitiators can be of any type. Preferably, they are chosen in the context of a radical polymerization from those which generate free radicals by a homolytic cleavage reaction in the α-position relative to the carbonyl group, such as benzoin ether derivatives, hydroxyalkylphenones, such as phenylbis(2,4,6-trimethylbenzoyl) phosphine oxide, and in the β-position, such as sulfide ketones and sulfonyl ketone derivatives, and those which form free radicals by abstraction of hydrogen from a hydrogen donor, such as benzophenones or thioxanthones. The process involves a charge transfer complex with an amine, followed by electron and proton transfer, to eventually form an initiating alkyl radical and an inactive cetyl radical. Mention may be made of benzyl diacetals, hydroxyalkylphenones, alpha-aminoketones, acylphosphine oxides, benzophenones, thioxanthones and in particular phenylbis(2,4,6-trimethylbenzoyl) phosphine oxide.

It would not be departing from the scope of the invention to use a combination of several photoinitiators, or alternatively a combination of photoinitiators and radical initiator(s) whose radicals are generated thermally or by an oxidation-reduction reaction, for example the methylenebis (diethyl malonate)-cerium IV pairing, an aromatic amine of toluidine type or alternatively the H₂O₂/Fe²⁺ pairing.

Among the initiators combined with the photoinitiators or used alone, mention may be made of diacyl peroxides, peroxyesters, dialkyl peroxides, peroxyacetals and azo compounds. Radical initiators which may be suitable are, for example, isopropyl carbonate, benzoyl, lauroyl, caproyl or dicumyl peroxide, tert-butyl perbenzoate, tert-butyl per-2-ethylhexanoate, cumyl hydroperoxide, 1,1-di (tert-butylperoxy)-3,3,5-trimethylcyclohexane, tert-butyl peroxyisobutyrate, tert-butyl peracetate, tert-butyl perpivalate, amyl perpivalate and tert-butyl peroctoate.

In the case of cationic polymerization, the photoinitiators will be compounds of the photoacid generator type which release acid species such as protons under electromagnetic irradiation, such as onium salts, for example diaryliodonium or triarylsulfonium salts, and ferrocenium salts.

The compositions C comprising a mixture M of monomers and initiator may additionally comprise one or more fillers D. Thus, the invention also comprises the compositions of the invention C in the presence of a mixture M of monomers, initiator and fillers D.

The fillers which can be used in the context of the invention may be inorganic or organic fillers. Among the inorganic fillers, mention may be made, without any limitation, of glass, preferably in the form of beads, calcium carbonate, talc, mica, kaolin, clays, sands, barium sulfate, feldspar, calcium phosphate, and silicas. Preferably, these are glass beads whose size varies from 50 to 1000 μm by volume and preferably between 50 to 500 μm and more preferably from 80 to 200 μm and calcium carbonate whose size varies from 50 to 1000 μm by volume and preferably between 50 to 500 μm and more preferably from 80 to 200 μm.

The organic fillers which can be used in the context of the invention may be chosen in a non-limiting manner from wood, cork, cereals, flax, barks or fruit stones. Organic fillers can also be products resulting from textile recycling processes but also from the recycling of thermosetting polymer compositions, or else from recycling of composite materials, that is to say fillers which themselves can be composed of organic and inorganic materials.

It is also possible to combine fillers, whether organic or inorganic, resulting from textile recycling processes or processes of recycling thermosetting polymer compositions, or else of recycling composite materials.

Thus, the combination of inorganic fillers and fillers from recycled materials improves the carbon footprint of the composition. With the ubiquity of composite materials today, being able to recycle them has become an important issue. Thus, one of the preferred compositions of the invention comprises a mixture of inorganic fillers and fillers resulting from the recycling of composite materials, and more particularly of glass beads with composite materials.

Composite material means an assembly of at least two immiscible materials. The fillers D may be present in proportions by mass of D of between 1% and 80% of the mass C+M+D and preferably between 50% and 80% of the mass C+M+D.

The compositions of the invention exhibit the best rheological characteristics after activation. Activation is understood to mean a residence with stirring of the compositions of the invention at a temperature of between 25 and 80° C., preferably between 60 and 80° C., for a time of between 30 minutes to 8 hours, formulated with other components such as monomers, initiators or fillers. This step can be completed in a dedicated capacity or in a kneading tool such as an extruder which in the case of 3D printing can be the extrusion device upstream of the nozzle placing the material within the manufacturing process for the part in 3D.

Thus, the invention also comprises the compositions of the invention in the presence of monomers M, initiators or fillers in activated form.

The activation step often described as a drawback has an advantage in the present invention. Thus it is possible to easily mix the compositions of the invention with fillers, for example, before the activation step, because at this stage the viscosity of the mixture is minimized. Obtaining a homogeneous mixture is facilitated and the mixture can then be activated according to known means, typically by applying a temperature and stirring for a given time. The activated mixture then has the desired characteristics of viscosity and yield stress.

Once polymerized, the compositions of the invention exhibit good mechanical properties and little shrinkage. The exothermy is controlled and the objects made by 3D printing do not present any defects.

The invention therefore also relates to a 3D printing process using the compositions of the invention and also to the objects obtained with the aid of this process.

The invention also relates to the use of the compositions of the invention in processes of injection, extrusion, molding or any other process for shaping thermoplastic materials, such as impregnation of composites, and also to the objects thus obtained.

The compositions of the invention may also comprise additional additives, among which UV stabilizers, plasticizers and antioxidants may be mentioned in a non-limiting manner.

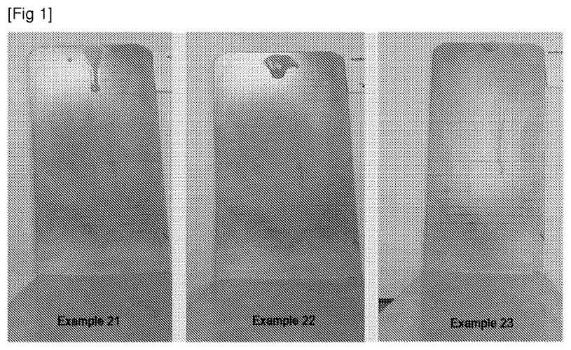

Figure: FIG. 1 illustrates the flow of formulations comprising the compositions of the invention and comparative compositions.

### EXAMPLES

The following examples illustrate the invention in a non-limiting manner. Starting materials used:

Methyl methacrylate (MMA) from Aldrich is used as a model of a monomer of low molecular mass and therefore of low viscosity. It is used as a monomer in the examples showing the viscosity and the yield stress using compositions of the invention or without the compositions of the invention.

Isobornyl acrylate (IBOA) is used in the examples more representative of the compositions of the invention, in combination with Sarbio® 7107, which is a monomer from Sartomer and has two acrylate functionalities and is derived from vegetable oil (epoxidized soybean oil diacrylate).

The hydrogenated castor oil (HCO) used is from Aldrich.

A diamide which can be used in the context of the invention is prepared as follows: 25.8 grams of ethylenediamine (0.43 mol, 0.86 amine equivalent), 135.52 grams of 12-hydroxystearic acid (0.43 mol, 0.43 acid equivalent) from Aldrich and 49.94 grams of hexanoic acid (0.43 mol, 0.43 acid equivalent) from Aldrich are introduced under a stream of nitrogen into a 1 liter round-bottom flask equipped with a thermometer, a Dean Stark apparatus, a condenser and a stirrer. The mixture is heated to 200° C., still under a stream of nitrogen. The water removed accumulates in the Dean Stark from 150° C. The reaction is checked by the acid and amine index. When the acid and amine values are 5 and 3.5 mg KOH/g, respectively, the reaction mixture is cooled to 150° C. and 0.65 g of sulfuric acid is added. The amine index checked 30 minutes later is less than 0.01 mg KOH/g. The reaction mixture is then discharged into a silicone mold. Once cooled to room temperature, the product is micronized in an air jet mill.

This diamide is used in examples 1 to 4.

The block copolymers used are of two types:
PMMA-pBuA-PMMA, denoted BCP 1.
P (MMA co IPA)-pBuA-p(MMA co IPA), denoted BCP 2.

The block copolymers are prepared according to a protocol described for example in EP1526138.

The fillers used are glass beads. TechBeads® 90-150 available from Weissker GmbH.

The photoinitiator used is Irgacure® 819 available from Aldrich.

Measurement methods:

Glass transition temperature measurement by DMA:

The DMA is determined using a Rheometric Scientific ARES rheometer under the following conditions:
rectangular torsion geometry;
shear deformation at the frequency of 1 Hz;
temperature range varying from −125 to 150° C.

The viscosity is measured with an Anton Paar MCR301 instrument at 25° C. and a shear gradient at from 0.1 to 100 s-1, with Couette geometry and a CC27-SN13118 mobile.
The yield stress is measured with an Anton Paar MCR301 instrument at 25° C. with a Couette geometry and a CC27-SN13118 mobile. The measurement is carried out in a stress gradient from 1 to 100 Pa.
The shrinkage is measured by a difference in density of the formulations before and after photopolymerization. The density of the formulation is measured using a 10 mL pycnometer. The density of the solid (product obtained from the formulation) is obtained by measuring the mass in water and in air.

Exothermicity: The exothermicity is determined by calculating the difference between the temperature measured during polymerization using a temperature probe and the temperature in the oven.

### Impact: ISO 179-1:2010.

The formulations comprising the compositions of the invention are activated at 60° C. with stirring (at 3000 rpm) for 6 h.

### Example 1

In this example, the viscosities and yield stresses for compositions of the invention and comparative compositions are measured after activation, with the monomer methyl methacrylate (MMA).

Table 1 collates the characteristics measured for these compositions:

TABLE 1

| | | | | | viscosity | yield |
|---|---|---|---|---|---|---|
| | MMA % | BCP1% | diamide % | HCO % | (Pa · s) at 1 s⁻¹ | stress (Pa) |
| 1 comparative | 100 | 0 | 0 | 0 | <1 | none |
| 2 comparative | 98.6 | 0 | 0.7 | 0.7 | 1 | none |
| 3 comparative | 70 | 30 | 0 | 0 | 0.8 | none |
| 4 comparative | 70 | 29 | 1 | 0 | 0.9 | none |
| 5 comparative | 70 | 29 | 0 | 1 | 0.8 | none |
| 6 invention | 70 | 29 | 0.5 | 0.5 | 19.2 | 8 |

It is noted in table 1 that only the composition of the invention exhibits a high level of viscosity and a measurable yield stress.

### Example 2

In this example, the viscosities and yield stresses for compositions of the invention and comparative compositions are measured after activation, with the monomers isobornyl acrylate (IBOA) and Sarbio® 7107.

Table 2 collates the characteristics measured for these compositions:

TABLE 2

| | | Sarbio ® | | | | viscosity | yield |
|---|---|---|---|---|---|---|---|
| | IBOA % | 7107 | BCP2% | diamide % | HCO % | (Pa · s) at 1 s⁻¹ | stress (Pa) |
| 7 comparative | 80 | 20 | 0 | 0 | 0 | 0.04 | none |
| 8 comparative | 76.2 | 19 | 4.8 | 0 | 0 | 0.12 | none |
| 9 comparative | 75.2 | 19 | 4.8 | 1 | 0 | 0.15 | none |
| 10 comparative | 75.2 | 19 | 4.8 | 0 | 1 | 0.12 | none |
| 11 invention | 75.2 | 19 | 4.8 | 0.5 | 0.5 | 7.7 | 5 |
| 12 comparative | 56 | 14 | 30 | 0 | 0 | 58 | none |
| 13 comparative | 63 | 16 | 21 | 0 | 0 | 8 | none |
| 14 comparative | 63 | 16 | 20 | 1 | 0 | 7 | none |
| 15 comparative | 63 | 16 | 20 | 0 | 1 | 8 | none |
| 16 invention | 63 | 16 | 20 | 0.5 | 0.5 | 14.4 | 5 |
| 17 invention | 63 | 16 | 19 | 1 | 1 | 38.3 | 26 |
| 18 invention | 61 | 15.2 | 19.2 | 2.3 | 2.3 | 183 | 44 |

In table 2 it is observed that the best viscosity and yield stress characteristics are provided by the compositions of the invention. Comparative example 12, which has very high proportions of block copolymer, exhibits an acceptable viscosity level but has no measurable yield stress.

### Example 3

In this example, the yield stresses are measured for compositions of the invention and comparative compositions in the presence of fillers (glass beads) after activation, with the monomers isobornyl acrylate (IBOA) and Sarbio® 7107.

Table 3 collates the characteristics measured for these compositions:

TABLE 3

| | glass | | Sarbio ® | | diamide | HCO | yield |
|---|---|---|---|---|---|---|---|
| | beads % | IBOA % | 7107% | BCP2% | % | % | stress (Pa) |
| 19 comparative | 70 | 22.8 | 5.7 | 1.5 | 0 | 0 | 5 |
| 20 invention | 70 | 22.5 | 5.7 | 1.5 | 0.15 | 0.2 | 25 |
| 21 comparative | 75 | 19 | 4.75 | 1.25 | 0 | 0 | 5 |
| 22 comparative | 75 | 19.8 | 4.95 | 0 | 0.125 | 0.1 | 50 |
| 23 invention | 75 | 18.8 | 4.7 | 1.25 | 0.125 | 0.1 | 100 |

In table 3, with compositions of the invention in the presence of fillers (glass beads), the yield stresses are at maximum with the compositions of the invention.

A flow test was carried out on aluminum plates arranged at an angle of 15° from the vertical. 5 g of sample are placed at the top of the plates and the flow of material is measured after 5 minutes. Comparative sample 21 shows a flow of 5.5 cm.

Comparative sample 22 shows a flow of 3 cm.

The sample of the invention 23 shows no flow.

FIG. 1 is a photograph of the plates 1 minute after deposition of the samples.

### Example 4

In this example, the characteristics of exothermicity, impact resistance and shrinkage are evaluated.

The formulations are cast in a Teflon mold to a thickness of about 2 mm.

The system is placed under a Delolux 03S UV lamp(Delo) at 8 cm from the source. The lamp has an emission spectrum of 320 to 600 nm and a power of 400 W. The system is irradiated for 1 minute 30 seconds.

Table 4 collates the characteristics measured for these compositions after activation and polymerization:

TABLE 4

| | glass | | | | | | | | | |
|---|---|---|---|---|---|---|---|---|---|---|
| | beads | IBOA | Sarbio ® | | diamide | HCO | photo- | impact | exothermicity | shrinkage |
| | % | % | 7107% | BCP2% | % | % | initiator | (KJ/m²) | (° C.) | % |
| 24 comparative | 0 | 98 | 0 | 0 | 0 | 0 | 2 | | 74 | |
| 25 comparative | 75 | 24.5 | 0 | 0 | 0 | 0 | 0.5 | | 6 | |
| 26 comparative | 0 | 93.1 | 0 | 4.9 | 0 | 0 | 2 | | 37 | 7.4 |
| 27 comparative | 0 | 88.2 | 0 | 9.8 | 0 | 0 | 2 | | 21 | 6.1 |
| 28 invention | 0 | 87.2 | 0 | 9.8 | 0.5 | 0.5 | 2 | | 6 | 4 |
| 29 comparative | 0 | 0 | 97 | 0 | 0.5 | 0.5 | 2 | 3.2 | | |
| 30 comparative | 0 | 78 | 19 | 0 | 0.5 | 0.5 | 2 | 8.6 | | 5.8 |
| 31 invention | 0 | 74 | 18 | 5 | 0.5 | 0.5 | 2 | 11.8 | | 4.6 |
| 32 comparative | 0 | 97 | 0 | 0 | 0.5 | 0.5 | 2 | | | 7.2 |

The example of the invention shows a clearly managed exothermicity, less than that of comparative example 25 in the presence of glass beads which are known to dissipate the exothermicity.

The examples in the presence of the block copolymer show a reduction in shrinkage, and in a more pronounced manner in the case of examples 28 and 31 of the invention.

1. A mass composition comprising the following mixture C:
at least one block copolymer in proportions of between 50% and 99%;
hydrogenated castor oil in proportions of between 0.5% and 25%;
at least one fatty acid diamide and/or at least one fatty acid triamide in proportions of between 0.5% and 25%;
the % being expressed in mass form for the total of mass C.

2. The composition as claimed in claim 1, further comprising a mixture M of at least one monomer in proportions by mass of C of between 1% and 40% relative to the mass M+C.

3. The composition as claimed in claim 2, further comprising an initiator in proportions by mass of between 0.1% and 5% of the mass M.

4. The composition as claimed in claim 3, wherein the initiator is a radical initiator.

5. The composition as claimed in claim 4, wherein the initiator is a radical initiator is of a photoinitiator type.

6. The composition as claimed in claim 3, wherein the initiator is a cationic initiator of a photoinitiator type.

7. The composition as claimed in claim 2, further comprising one or more fillers D in proportions by mass D of between 5% and 80% of the charge C+M+D.

8. The composition as claimed in claim 7, wherein the fillers are inorganic.

9. The composition as claimed in claim 7, wherein the fillers are organic.

10. The composition as claimed in claim 7, wherein the fillers are a combination of inorganic fillers and fillers resulting from a process of recycling textile materials or recycling thermosetting polymeric compositions, or else recycling composite materials.

11. The composition as claimed in claim 7, wherein the fillers are glass beads.

12. The composition as claimed in claim 2, wherein M consists of a combination of monofunctional and polyfunctional monomers in respective mass ratios varying from 4/1 to 1/4.

13. The composition as claimed in claim 12, wherein the monofunctional monomers are selected from the group consisting of styrene, methyl, ethyl, butyl and isobornyl (meth)acrylates and vinyl ethers and the polyfunctional monomers are chosen from dipentaerythritol hexaacrylate, trimethylpropane triacrylate, 1,6-hexanediol diacrylate, pentaerythritol triacrylate, tripropylene glycol diacrylate, triethylene glycol dimethacrylate, ethylene glycol dimethacrylate, ethylene glycol diacrylate, 1,10 decanediol di(meth)acrylate, polyethylene glycol (meth)acrylates, polyfunctional (meth)acrylates from renewable resources, such as vegetable oil (meth)acrylates, and vinyl ethers.

14. The composition as claimed in claim 1, wherein the at least one block copolymer is selected from the group consisting of di-blocks or tri-blocks, alone or in combinations, consisting of A blocks having a Tg of greater than 25° C., and B blocks having a Tg of less than 0° C., linear or star-shaped, of formula (A)ₙB or (B)ₙA, where n takes the values of 2 or 3.

15. The composition as claimed in claim 1, wherein:
the at least one fatty acid diamide comprises at least one reaction product obtained from a reaction mixture comprising:
a) at least one diamine, the diamine being chosen from a C₂ to C₂₄ and preferably C₂ to C₁₀ aliphatic diamine, a C₆ to C₁₈ and preferably C₆ to C₁₂ cycloaliphatic diamine, a C₆ to C₂₄ and preferably C₆ to C₁₂ aromatic diamine, a C₇ to C₂₄ arylaliphatic diamine, and mixtures thereof;
b) at least one carboxylic acid, the carboxylic acid being a C₂ to C₃₆ carboxylic acid,
the at least one fatty acid triamide comprises at least one reaction product obtained from a reaction mixture comprising:
a) at least one triamine, selected from the group consisting of a C2 to C24 aliphatic triamine, a C6 to C18 cycloaliphatic triamine, a C6 to C24 aromatic triamine, a C7 to C24 arylaliphatic triamine, a polyether triamine, and mixtures thereof;
b) at least one carboxylic acid, the carboxylic acid being a C₂ to C₃₆ carboxylic acid.

16. The composition as claimed in claim 2, which wherein the composition is in activated form.

17. Use of the composition as claimed in claim 1 as an organogelator in a formulation of monomers, sealants, adhesives or paints.

18. Use of a composition as claimed in claim 3 in a process of 3D printing, injection, extrusion, molding or impregnation of composites.

19. A 3D printing process using a composition as claimed in claim 3.

20. An object obtained with the aid of the use as claimed in claim 18.
